(19) United States
(12) Patent Application Publication
(10) Pub. No.: US 2025/0244555 A1
(43) Pub. Date: Jul. 31, 2025

(54) OPTICAL ELEMENT DRIVE DEVICE

(71) Applicant: ALPS ALPINE CO., LTD., Tokyo (JP)

(72) Inventor: Katsuhiko OTOMO, Miyagi (JP)

(21) Appl. No.: 19/028,532

(22) Filed: Jan. 17, 2025

(30) Foreign Application Priority Data
Jan. 25, 2024 (JP) 2024-009350

(51) Int. Cl. G02B 7/08

(52) U.S. Cl. CPC G02B 7/08

(57) ABSTRACT

An optical element drive device includes: a fixed-side member; an optical element holder that includes a through-hole portion penetrating therethrough in a vertical direction and capable of holding an optical element; a support member configured to support the optical element holder so as to be movable in the vertical direction; and a driver configured to move the optical element holder at least in the vertical direction with respect to the fixed-side member. The fixed-side member includes a housing portion open at least on one of an upper side or a lower side, the optical element holder includes a projection a tip thereof being inserted into the housing portion, a vibration damper is accommodated in the housing portion, and the tip of the projection contacts the vibration damper provided in the housing portion.

### CROSS-REFERENCE TO RELATED APPLICATIONS

The present application is based on and claims priority to Japanese Patent Application No. 2024-009350 filed on Jan. 25, 2024, the entire contents of which are hereby incorporated by reference.

### BACKGROUND

### 1. Field of the Invention

The present disclosure relates to an optical element drive device mounted on, for example, a portable device.

### 2. Description of the Related Art

Conventionally, a lens unit drive device (optical element drive device) including a lens holder (optical element holder) and a coil arranged on an outer periphery of the optical element holder is known (see Japanese Laid-Open Patent Application No. 2021-140017). In this device, the optical element holder is held movably in a direction parallel to an optical axis of the lens by a pair of elastic members (plate springs) arranged above and below the optical element holder.

In this device, a vibration damper member (vibration damper) is accommodated in a recess provided on an upper surface of the optical element holder in order to prevent the optical element holder from vibrating undesirably due to external vibration and impact, etc., and a projection projecting downward from a top surface of a cover is configured to contact the vibration damper.

### SUMMARY

An optical element drive device according to an embodiment of the present disclosure is provided with: a fixed-side member; an optical element holder that includes a through-hole portion penetrating therethrough in a vertical direction and capable of holding an optical element; support members configured to support the optical element holder so as to be movable in the vertical direction; and a driver configured to move the optical element holder at least in the vertical direction with respect to the fixed-side member, wherein the fixed-side member includes a housing portion open at least on one of an upper side or a lower side; the optical element holder includes a projection a tip thereof being inserted into the housing portion; a vibration damper is accommodated in the housing portion; and the tip of the projection contacts the vibration damper provided in the housing portion.

### BRIEF DESCRIPTION OF THE DRAWINGS

FIG. 1 is an upper perspective view of an example configuration of the optical element drive device according to an embodiment of the present disclosure;

FIG. 2 is an exploded perspective view of the optical element drive device as illustrated in FIG. 1;

FIG. 3 is a bottom view of the optical element drive device as illustrated in FIG. 1;

FIG. 4 is an upper perspective view of the optical element drive device as illustrated in FIG. 1 with some components removed;

FIG. 5 is upper perspective views of the optical element holder, a coil, and metal members;

FIG. 6 is top and bottom views of the optical element holder, the coil, and the metal members;

FIG. 7 is lower perspective views of a spacer member and the optical element holder;

FIG. 8 is a cross-sectional view of the optical element drive device as illustrated in FIG. 1;

FIG. 9 is a bottom view of the optical element drive device as illustrated in FIG. 1 with some components removed;

FIG. 10 is perspective views of the coil, terminal members, the metal member, and a lower plate spring;

FIG. 11 is an exploded perspective view of another configuration of the optical element drive device according to the embodiment of the present disclosure;

FIG. 12 is upper perspective views of the metal members embedded in the optical element holder as illustrated in FIG. 11;

FIG. 13 is a top view of the optical element drive device as illustrated in FIG. 11 with some components removed; and

FIG. 14 is a cross-sectional view of the optical element drive device as illustrated in FIG. 11.

### DETAILED DESCRIPTION OF THE DISCLOSURE

However, in the above-described configuration, it is necessary to enlarge an opening of the top surface in order to form the projection, and foreign substances tend to enter into the optical element drive device through the opening. When the foreign substances adhere to the image sensor provided under the optical element drive device, the image may be affected.

Therefore, it is desirable to provide an optical element drive device capable of suppressing entry of the foreign substances into the optical element drive device while suppressing undesired vibration of the optical element holder.

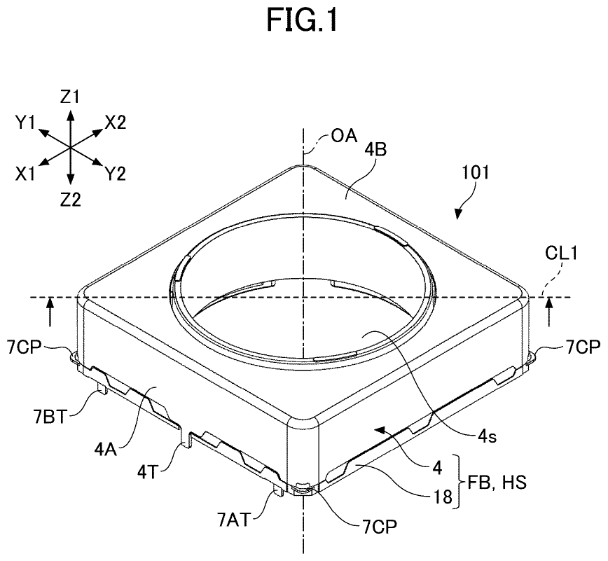

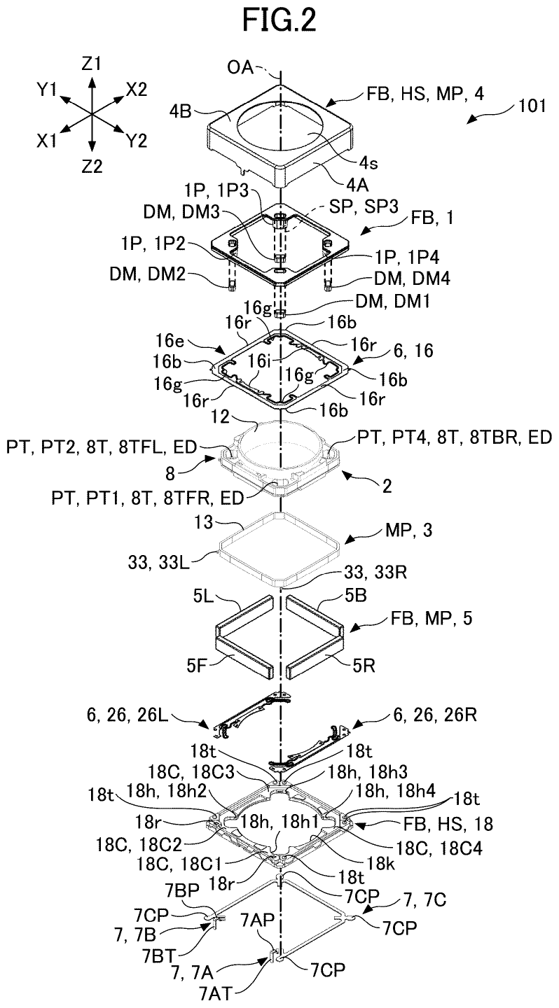

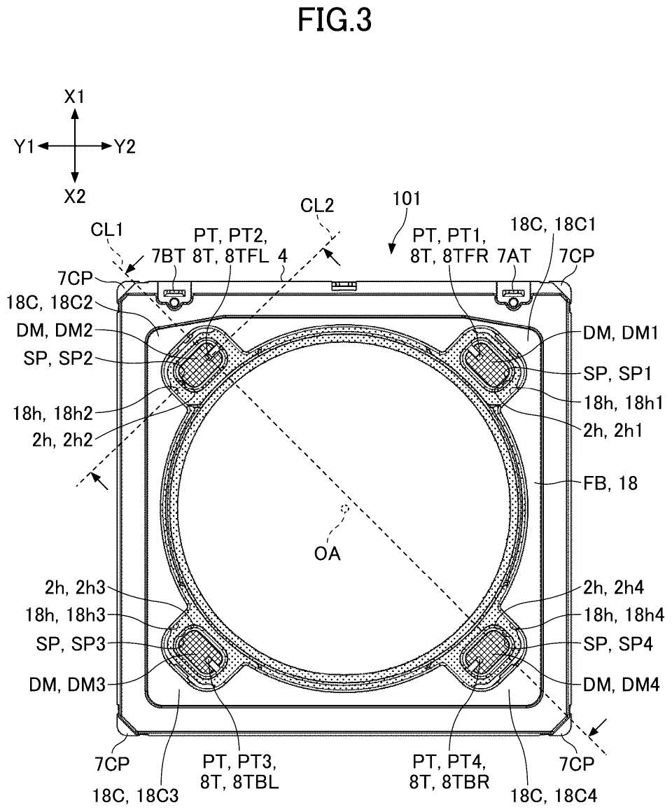

An optical element drive device 101 according to the embodiment of the present disclosure will be described below with reference to the drawings. FIG. 1 is an upper perspective view of the optical element drive device 101. FIG. 2 is an exploded perspective view of the optical element drive device 101. FIG. 3 is a bottom view of the optical element drive device 101.

In FIG. 1, X1 represents one direction of an X-axis constituting a three-dimensional orthogonal coordinate system, and X2 represents the other direction of the X-axis. Y1 represents one direction of a Y-axis of the three-dimensional orthogonal coordinate system, and Y2 represents the other direction of the Y-axis. Similarly, Z1 represents one direction of a Z-axis of the three-dimensional orthogonal coordinate system, and Z2 represents the other direction of the Z-axis. In FIG. 1, an optical axis OA extends parallel to the Z-axis. An X1 side of the optical element drive device 101 corresponds to a front (front side) of the optical element drive device 101, and an X2 side of the optical element drive device 101 corresponds to a back (rear side) of the optical element drive device 101. A Y1 side of the optical element drive device 101 corresponds to a left side of the optical element drive device 101, and a Y2 side of the optical element drive device 101 corresponds to a right side of the optical element drive device 101. A Z1 side of the optical element drive device 101 corresponds to an upper side of the optical element drive device 101, and a Z2 side of the optical element drive device 101 corresponds to a lower side of the optical element drive device 101. The same applies to other figures.

The optical element drive device 101, as illustrated in FIG. 2, includes an optical element holder 2 capable of holding an optical element (not illustrated), a driver MP capable of moving the optical element holder 2 along an optical-axis direction, plate springs 6 as support members for supporting the optical element holder 2 movably in the optical-axis direction, a fixed-side member FB to which one end of the plate spring 6 is fixed, and terminal members 7 (first terminal member 7A, second terminal member 7B, and third terminal member 7C) and metal members 8 for electrically connecting with other components. The optical element is, for example, an image sensor, a polarizing element, or a lens body. In the illustrated example, the optical element holder 2 is configured to hold a lens body. The lens body is, for example, a cylindrical lens barrel including at least one lens. The optical-axis direction includes a direction of the optical axis OA with respect to the lens body and a direction parallel to the optical axis OA.

As illustrated in FIG. 2, the driver MP includes a coil 3 wound in a rectangular annular shape, a cover 4 serving as an outer case including a rectangular cylindrical outer peripheral wall 4A, and rectangular parallelepiped magnets 5. The magnets 5 include a rear magnet 5B, a front magnet 5F, a left magnet 5L, and a right magnet 5R correspondingly facing to four sides of the coil 3. The fixed-side member FB includes a spacer 1, a cover 4, the magnets 5, and a base member 18 in which the terminal members 7 are embedded.

The plate springs 6 include an upper plate spring 16 disposed between the spacer 1 and the optical element holder 2, and lower plate springs 26 disposed between the optical element holder 2 and the base member 18. The lower plate springs 26 include a left lower plate spring 26L and a right lower plate spring 26R.

In the illustrated example in which the optical element is the lens body, as illustrated in FIG. 1, the optical element drive device 101 has a substantially rectangular parallelepiped shape and is mounted on a substrate (not illustrated) on which an image sensor (not illustrated) is mounted. The substrate, the optical element drive device 101, the lens body mounted on the optical element holder 2, and the image sensor mounted on the substrate so as to face the lens body are included in a camera module. The coil 3 is connected to a power supply through the metal members 8 embedded in the optical element holder 2, the lower plate springs 26, the terminal members 7 embedded in the base member 18, and the substrate. When a current flows through the coil 3, the driver MP generates an electromagnetic force along the optical-axis direction.

The optical element drive device 101 uses this electromagnetic force to achieve an automatic focusing function by moving the optical element holder 2 along the optical-axis direction on the Z1 side (subject side) of the image sensor. Specifically, the optical element drive device 101 moves the optical element holder 2 away from the image sensor to enable macro photographing, and moves the optical element holder 2 toward the image sensor to enable infinity focus photographing.

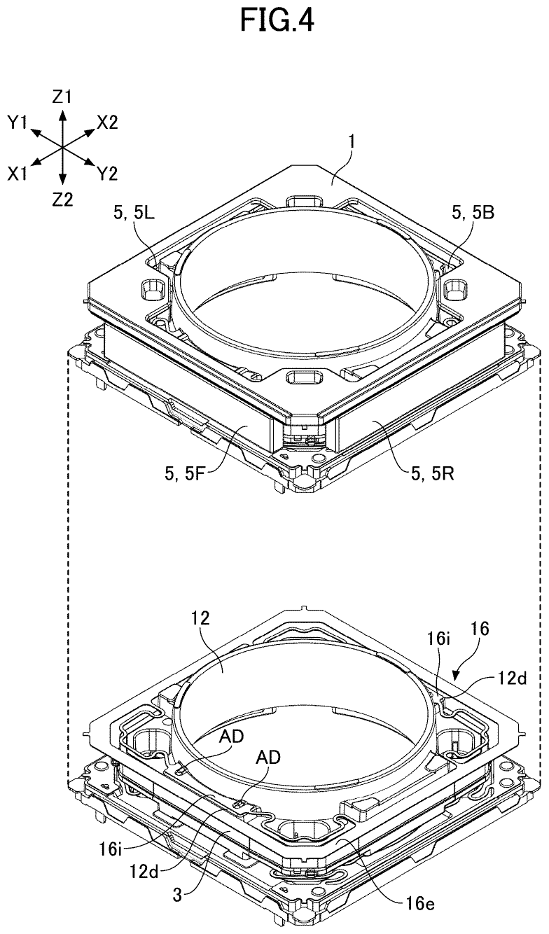

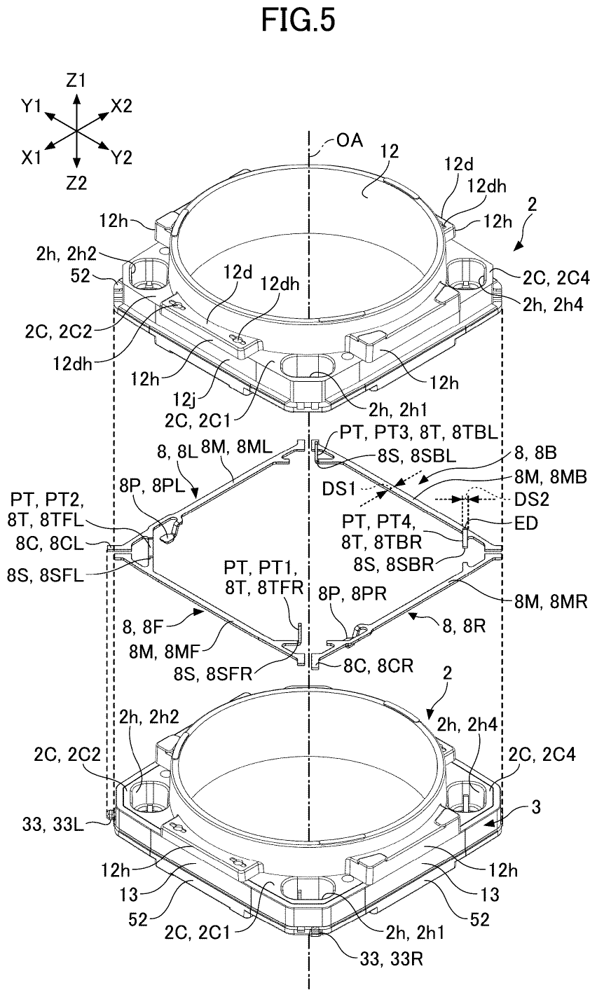

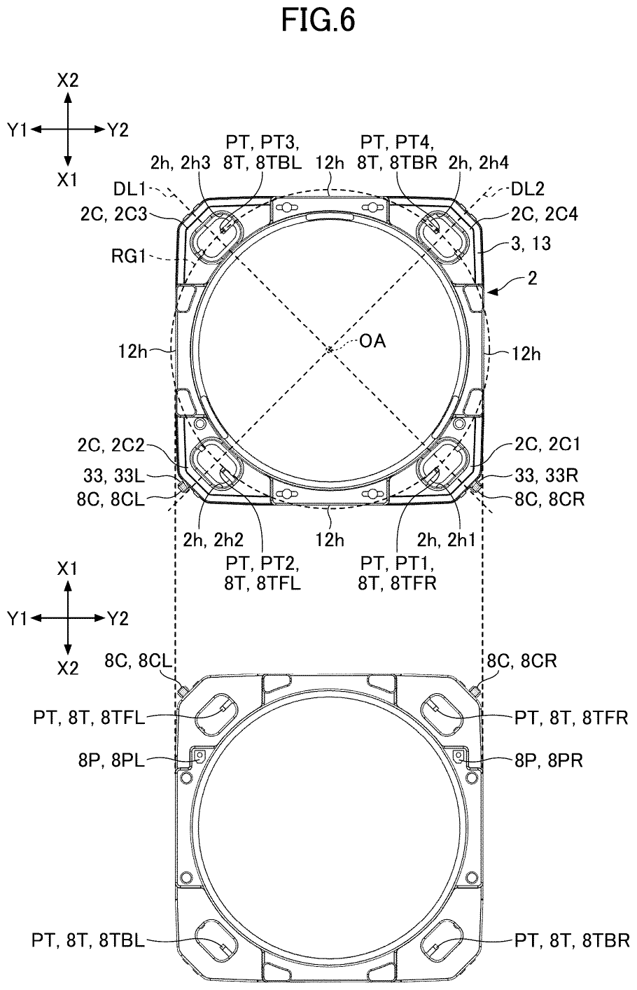

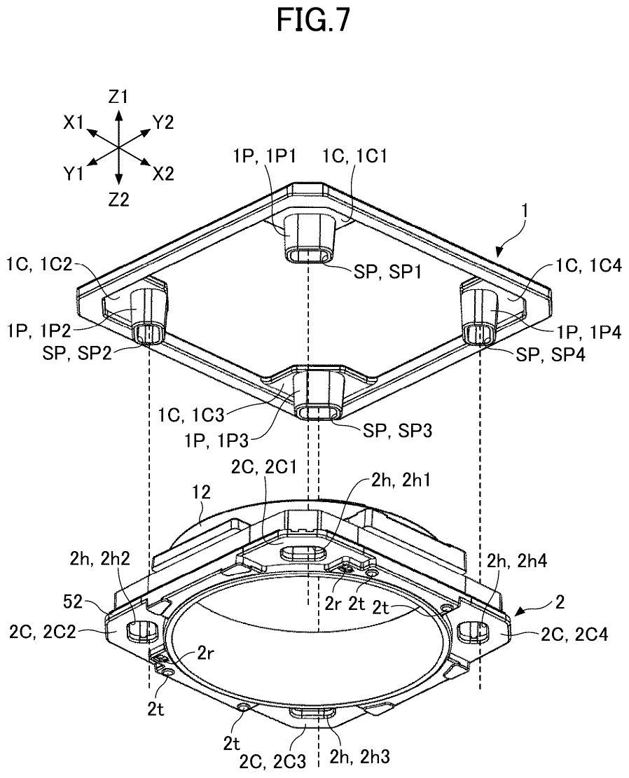

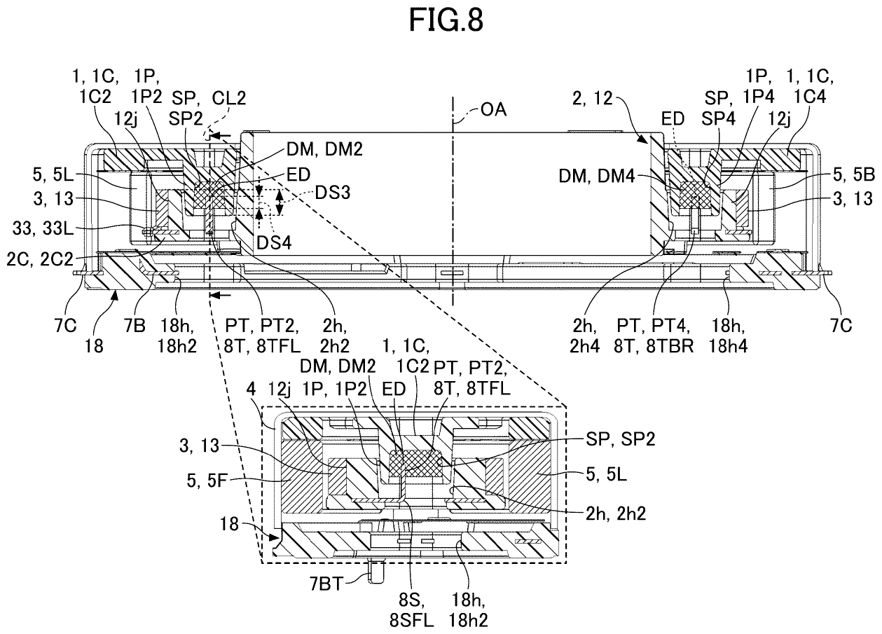

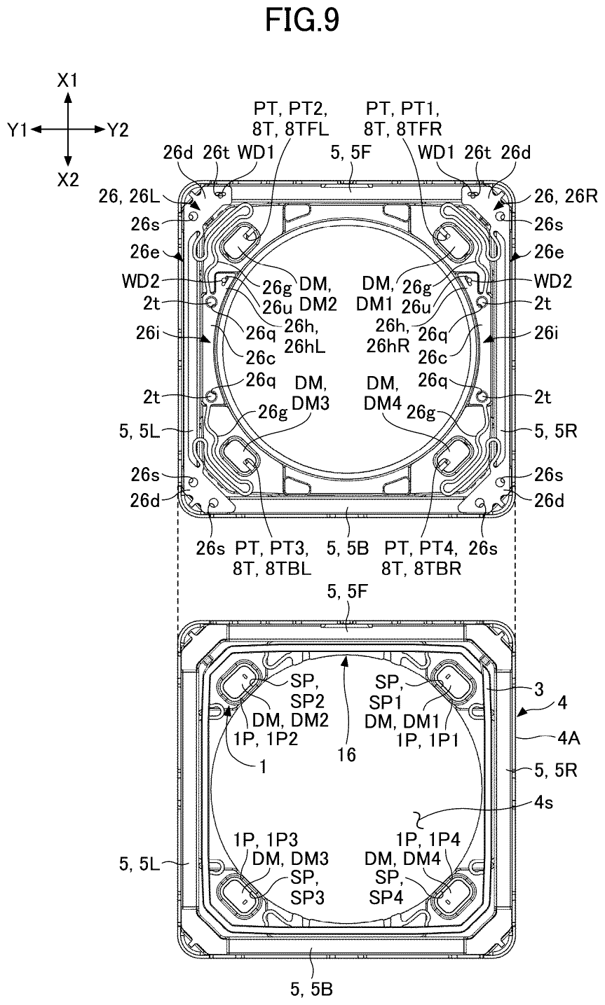

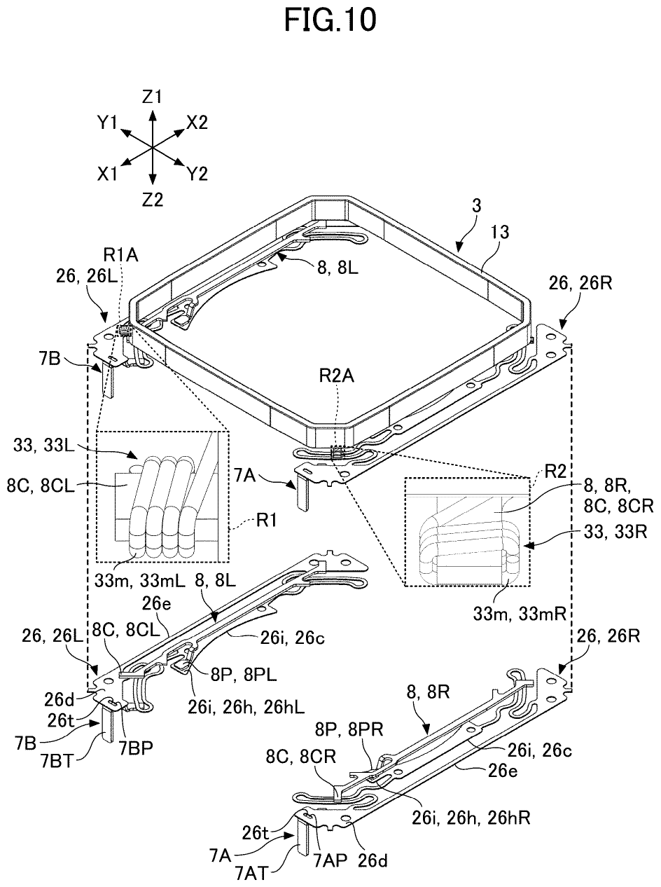

Next, the optical element holder 2 and the driver MP will be described. FIG. 4 is an upper perspective view of the optical element drive device 101 with some components removed. Specifically, the upper figure of FIG. 4 is an upper perspective view of the optical element drive device 101 in a state where the cover 4 is removed, and the lower figure of FIG. 4 is an upper perspective view of the optical element drive device 101 in a state where the spacer 1 and the magnets 5 are also removed. FIG. 5 is upper perspective views of the optical element holder 2, the coil 3, and the metal members 8. Specifically, the upper figure of FIG. 5 is an upper perspective view of the optical element holder 2, the center figure of FIG. 5 is an upper perspective view of the metal members 8 (rear metal member 8B, front metal member 8F, left metal member 8L, and right metal member 8R), and the lower figure of FIG. 5 is an upper perspective view of the optical element holder 2 in a state where the coil 3 is wound and the metal members 8 are embedded. FIG. 6 is views of the optical element holder 2 in a state where the coil 3 is wound and the metal members 8 are embedded. Specifically, the upper figure of FIG. 6 is a top view of the optical element holder 2, and the lower figure of FIG. 6 is a bottom view of the optical element holder 2. FIG. 7 is lower perspective views of the spacer 1 and the optical element holder 2. Specifically, the upper figure of FIG. 7 is a lower perspective view of the spacer 1, and the lower figure of FIG. 7 is a lower perspective view of the optical element holder 2. FIG. 8 is a cross-sectional view of the optical element drive device 101. Specifically, the upper figure of FIG. 8 illustrates a cross section of the optical element drive device 101 in an imaginary plane parallel to the optical axis OA, including a cutting line CL1 in FIGS. 1 and 3. The lower figure of FIG. 8 illustrates a cross section of the optical element drive device 101 in an imaginary plane parallel to the optical axis OA including a cutting line CL2 (perpendicular to the cutting line CL1) in FIG. 3 and the upper figure of FIG. 8. FIG. 9 is a bottom view of the optical element drive device in a state where some of the components are removed. Specifically, the upper figure of FIG. 9 is a bottom view of the optical element drive device in a state where the terminal members 7 and the base member 18 are removed, and the lower figure of FIG. 9 is a bottom view of the optical element drive device in a state where the optical element holder 2, the metal members 8, and the lower plate springs 26 are removed. FIG. 10 is views illustrating paths of the current flowing through the coil 3. Specifically, the upper figure of FIG. 10 is an upper perspective view of the coil 3, the first terminal member 7A, the second terminal member 7B, the left metal member 8L, the right metal member 8R, the left lower plate spring 26L, and the right lower plate spring 26R. The lower figure of FIG. 10 is an upper perspective view of the first terminal member 7A, the second terminal member 7B, the left metal member 8L, the right metal member 8R, the left lower plate spring 26L, and the right lower plate spring 26R. In FIG. 10, an area R1 surrounded by a broken line is an enlarged view of an area RIA surrounded by the broken line, and in FIG. 10, an area R2 surrounded by the broken line is an enlarged view of an area R2A surrounded by the broken line.

In the illustrated example, the optical element holder 2 is manufactured by injection molding a synthetic resin such as a liquid crystal polymer (LCP). Specifically, as illustrated in the upper figure of FIG. 5, the optical element holder 2 includes a cylindrical portion 12 as a through-hole portion which extends along the optical-axis direction, and a flange (brim portion) 52 which is formed on an image sensor side (Z2 side) in the optical-axis direction. The upper half of the cylindrical portion 12 is substantially cylindrical.

The cylindrical portion 12 is formed such that the lens body is mounted on an inner peripheral surface thereof. Furthermore, two pedestal portions 12d are provided at places facing each other across the optical axis OA, on an end surface of the cylindrical portion 12 on the subject side. Two recesses 12dh are provided in each of the two pedestal portions 12d. Inner portions 16i of the upper plate spring 16 are placed on the pedestal portions 12d, as illustrated in the lower figure of FIG. 4.

As illustrated in the upper figure of FIG. 5, a coil support 12j is provided on an outer peripheral surface of the cylindrical portion 12 as an outer wall portion for supporting the coil 3 from the inside. In the present embodiment, the coil support 12j has a substantially rectangular outer shape in a top view so as to support the substantially rectangular annular coil 3 in a top view. On the subject side of the coil support 12j, four eaves 12h projecting radially outward are formed. The eaves 12h are arranged so as to face the flange 52 in the optical-axis direction. As illustrated in the lower figure of FIG. 5, the coil 3 is mounted on an outer peripheral surface of the optical element holder 2 so as to be supported by the coil support 12j and held between the eaves 12h and the flange 52 in the optical-axis direction.

The flange 52 projects radially outward from the end of the cylindrical portion 12 on the image sensor side (Z2 side). The coil 3 is disposed on the subject side of the flange 52. The flange 52 includes four round projections 2t projecting downward (Z2 direction) from a surface on the image sensor side (Z2 side), as illustrated in the lower figure of FIG. 7.

Each of the four metal members 8 (rear metal member 8B, front metal member 8F, left metal member 8L, and right metal member 8R) has a base 8M embedded in the optical element holder 2, as illustrated in the center figure of FIG. 5. Specifically, the rear metal member 8B includes a rear base 8MB, the front metal member 8F includes a front base 8MF, the left metal member 8L includes a left base 8ML, and the right metal member 8R includes a right base 8MR. Two of the four metal members 8 (the left metal member 8L and the right metal member 8R) respectively include an extension 8C around which the extended-wire portion 33, which is a part of a conductive wire of the coil 3, is wound, as illustrated in the center figure and the lower figure of FIG. 5. Specifically, the left metal member 8L includes a left extension 8CL, and the right metal member 8R includes a right extension 8CR. The extended-wire portion 33 includes a right extended-wire portion 33R, which is a part of the wire on a winding-start side of the coil 3, and a left extended-wire portion 33L, which is a part of the wire on a winding-end side of the coil 3. The right extended-wire portion 33R is wound around the right extension 8CR, and the left extended-wire portion 33L is wound around the left extension 8CL.

Thus, two of the four metal members 8 (the left metal member 8L and the right metal member 8R) are used as conductive paths, but the remaining two of the four metal members 8 (the front metal member 8F and the rear metal member 8B) are not used as conductive paths. Therefore, the four metal members 8 are connected to each other when embedded in the optical element holder 2 by injection molding, but are separated from each other when assembled. Therefore, even when two of the four metal members 8 (the left metal member 8L and the right metal member 8R) generate heat by energization, the heat is not appreciably transmitted to the remaining two of the four metal members 8 (the front metal member 8F and the rear metal member 8B) by conduction.

As illustrated in the upper figure of FIG. 9, the projections 2t include two projections 2t that correspond to two through holes 26q formed in the left lower plate spring 26L and two projections 2t that correspond to two through holes 26q formed in the right lower plate spring 26R. Then, inner portions 26i serving as a first support (movable-side support) of the left lower plate spring 26L and the right lower plate spring 26R are attached and fixed to the projections 2t. The fixing of the inner portions 26i of the left lower plate spring 26L and the right lower plate spring 26R is achieved by thermally caulking the projections 2t inserted into the through holes 26q formed in the inner portions 26i. In the lower figure of FIG. 7 and the upper figure of FIG. 9, the projections 2t are illustrated in a state where the tips of the projections 2t are deformed after being thermally caulked. The same applies to other figures illustrating the projections 2t.

Next, the driver MP of the optical element drive device 101 will be described. As illustrated in FIG. 2, the driver MP includes the coil 3, the cover 4, and the magnets 5. The magnets 5 include the rear magnet 5B, the front magnet 5F, the left magnet 5L, and the right magnet 5R, each arranged so as to face corresponding one of the four sides of the cover 4. The driver MP generates a driving force (thrust) by the current flowing through the coil 3 and a magnetic field generated by the magnets 5, and can move the optical element holder 2 up and down along the optical-axis direction.

As illustrated in the lower figure of FIG. 5, the coil 3 is formed by arranging a conductive wire (conductor) on the outer periphery of the optical element holder 2. Specifically, the coil 3 includes a winding 13 as a coil body formed by being wound in a rectangular annular shape, and an extended-wire portion 33 extending from the winding 13 and wound around the extension 8C. In the lower figure of FIG. 5, for clarity, a detailed illustration of a winding state of the conductive wire whose surface is covered with an insulating member is omitted from the drawing of the winding 13. That is, the winding 13 is illustrated in a simplified manner. The same applies to other figures illustrating the winding 13.

The extended-wire portion 33 includes the left extended-wire portion 33L connected to an end (winding-end portion) of the winding 13 located on an outer peripheral side of the winding 13 on the winding-end side of the coil 3, and a right extended-wire portion 33R connected to an end (winding-start portion) of the winding 13 located on an inner peripheral side of the winding 13 on the winding-start side of the coil 3.

In the illustrated example, the extended-wire portion 33 includes a winding portion 33m wound around the extension 8C, as illustrated in FIG. 10. Specifically, the winding portion 33m includes a right winding portion 33mR wound around the right extension 8CR for 3 turns and a left winding portion 33 mL wound around the left extension 8CL for 3 turns.

In the illustrated example, the right extended-wire portion 33R is wound around the right extension 8CR of the right metal member 8R embedded in the optical element holder 2 before the wire constituting the coil 3 is wound around the coil support 12j of the optical element holder 2. Thus, as illustrated in FIG. 10, the right winding portion 33mR is formed around the right extension 8CR, and a part of the right extended-wire portion 33R is held in the right extension 8CR. However, the right extended-wire portion 33R may be wound around the right extension 8CR after the wire constituting the coil 3 is wound around the coil support 12j of the optical element holder 2.

The winding 13 of the coil 3 wound around the coil support 12j of the optical element holder 2 is arranged at a position surrounding the periphery of the optical element holder 2, as illustrated in the lower figure of FIG. 5. The winding 13 is supported from the inside by the coil support 12j, and is fixed to the subject side of the flange 52 so as to be held between the eaves 12h and the flange 52. In addition, since the inner peripheral surface of the winding 13 is supported by the coil support 12j in an isotropically balanced manner, the winding 13 is held by the optical element holder 2 in a state in which the central axis of the coil 3 is aligned with the central axis of the optical element holder 2. Therefore, the optical axis OA of the lens body held by the optical element holder 2 is configured to readily align with the central axes of the optical element holder 2 and the coil 3.

When the wire is wound around the outer periphery of the optical element holder 2, the left extended-wire portion 33L that extends to the end of the winding 13 is wound around the left extension 8CL of the left metal member 8L embedded in the optical element holder 2, as illustrated in FIG. 10.

Next, the cover 4 included in the driver MP will be described. In the illustrated example, the cover 4 is made by applying punching and drawing to a plate made of a soft magnetic material such as iron, and functions as a yoke. Specifically, as illustrated in FIG. 1, the cover 4 has a box-shaped outer shape defining a casing 4s. The cover 4 includes a rectangular cylindrical outer peripheral wall 4A and a ceiling 4B shaped as a substantially rectangular annular flat plate provided so as to continue with an upper end (Z1-side end) of the outer peripheral wall 4A. The cover 4 thus configured accommodates the coil 3 and the magnets 5 in the casing 4s as illustrated in the lower figure of FIG. 9, and is coupled to the base member 18 to form a housing HS together with the base member 18 as illustrated in FIG. 1. However, the cover 4 may be formed of a non-magnetic material such as austenitic stainless steel.

Next, the magnets 5 included in the driver MP will be described. Each of the magnets 5 is a bipolar magnetized permanent magnet and has a substantially rectangular parallelepiped shape as illustrated in FIG. 2. The magnets 5 are positioned outside the coil 3 as illustrated in the lower figure of FIG. 9 and are arranged along the four sides of the substantially rectangular cylindrical outer peripheral wall 4A constituting the cover 4. Each of the four magnets 5 is fixed to the inner peripheral surface of the cover 4 by an adhesive, and is arranged such that, for example, an inner side of the magnet 5 is an N pole and the outer side of the magnet 5 is an S pole. However, each of the four magnets 5 may be arranged such that the inside of the magnet 5 is the S pole and the outside of the magnet 5 is the N pole.

The plate springs 6 are made of a metal plate mainly made of copper alloy. As illustrated in FIG. 2, the plate springs 6 include the upper plate spring 16 arranged between the optical element holder 2 and the cover 4 (specifically, the spacer 1), and the lower plate springs 26 arranged between the optical element holder 2 and the base member 18. When the optical element holder 2 and the plate springs 6 (the upper plate spring 16, the left lower plate spring 26L, and the right lower plate spring 26R) are combined, the plate springs 6 support the optical element holder 2 such that the optical element holder 2 can be moved in the optical-axis direction (Z-axis direction). The lower plate springs 26 also function as a power supply member for supplying current to the coil 3. Therefore, as illustrated in FIG. 10, the left lower plate spring 26L is electrically connected to one end of the coil 3 through the left metal member 8L, and the right lower plate spring 26R is electrically connected to the other end of the coil 3 through the right metal member 8R. The spacer 1 is arranged between the upper plate spring 16 and the cover 4.

The spacer 1 is arranged so as to prevent the optical element holder 2 from colliding with the cover 4 when the optical element holder 2 moves in the Z1 direction. That is, the spacer 1 is arranged such that a space can be formed between the optical element holder 2 and the ceiling 4B of the cover 4. However, when a space can be formed between the optical element holder 2 and the ceiling 4B of the cover 4 by another structure or the like, the spacer 1 may be omitted. In the illustrated example, the spacer 1 is manufactured by injection molding a synthetic resin such as a liquid crystal polymer (LCP).

As illustrated in FIG. 2, the upper plate spring 16 has a substantially rectangular annular outer shape and includes the inner portions 16i as the first support (movable-side support) fixed to the optical element holder 2, an outer portion 16e as a second support (fixed-side support) fixed to the fixed-side member FB, and four elastic arms 16g each being located between the corresponding inner portion 16i and the outer portion 16e. Specifically, the outer portion 16e includes four corners 16b and four bridges 16r connecting the four corners 16b. Each of the four bridges 16r is held between the spacer 1 and the magnet 5 and fixed with an adhesive. The spacer 1, the cover 4, and the magnets 5 function as the fixed-side member FB.

When the upper plate spring 16 is assembled to the optical element holder 2, the inner portions 16i are placed on the pedestal portions 12d of the optical element holder 2, as illustrated in the lower figure of FIG. 4. The inner portions 16i are fixed to the optical element holder 2 by an adhesive applied to the recesses 12dh (see the upper figure in FIG. 5) formed in the pedestal portions 12d. The outer portion 16e contacts upper surfaces (Z1-side surfaces) of the magnets 5, is held between the spacer 1 and the magnets 5, and is fixed thereto by an adhesive. The outer portion 16e held and fixed between the spacer 1 and the magnets 5 functions as the fixed-side member FB.

The upper plate spring 16 is formed to be rotationally symmetric twice with respect to the optical axis OA. The upper plate spring 16 is fixed to the optical element holder 2 at the inner portions 16i, and is fixed to the cover 4 via the spacer 1 at the outer portion 16e. Therefore, the upper plate spring 16 can support the optical element holder 2 in a balanced manner.

As illustrated in the upper figure of FIG. 9, the left lower plate spring 26L and the right lower plate spring 26R are configured such that their inner shapes are substantially arcs. Each of the left lower plate spring 26L and the right lower plate spring 26R includes the inner portion 26i as the first support (movable-side support) fixed to the optical element holder 2, an outer portion 26e as the second support (fixed-side support) fixed to the fixed-side member FB, and two elastic arms 26g located between the inner portion 26i and the outer portion 26e.

As illustrated in the lower figure of FIG. 10, each inner portion 26i of the left lower plate spring 26L and the right lower plate spring 26R includes an inner joint 26c joined to the projections 2t of the optical element holder 2 and a connecting plate 26h facing an exposed portion 8P of the metal member 8. Specifically, the exposed portions 8P include a left exposed portion 8PL facing a left connecting plate 26hL of the left lower plate spring 26L and a right exposed portion 8PR facing a right connecting plate 26hR of the right lower plate spring 26R. The metal members 8 are embedded in the optical element holder 2 such that lower surfaces of the exposed portions 8P are exposed at recesses 2r (see the lower figure of FIG. 7) located at the lower surface of the optical element holder 2.

When the left lower plate spring 26L and the right lower plate spring 26R are assembled to the optical element holder 2, the four projections 2t of the optical element holder 2 are inserted into the circular through holes 26q provided in the inner joints 26c of the left lower plate spring 26L and the right lower plate spring 26R as illustrated in the upper figure of FIG. 9. Then, the inner joints 26c are fixed to the optical element holder 2, as illustrated in the upper figure of FIG. 9, for example, by applying heat caulking or cold caulking to the projections 2t. Thus, the inner portions 26i of the left lower plate spring 26L and the right lower plate spring 26R are positioned and fixed to the optical element holder 2.

The outer portion 26e of the left lower plate spring 26L includes outer joints 26d joined to the base member 18, as illustrated in the upper figure of FIG. 9. Through holes 26s are provided in the outer joints 26d of the left lower plate spring 26L and receive projections 18t (see FIG. 2) provided on an upper surface of the base member 18. Then, the projections 18t are fixed to the outer joints 26d by heat caulking or cold caulking. Thus, the outer portion 26e of the left lower plate spring 26L is positioned and fixed to the base member 18. The same applies to the right lower plate spring 26R. In FIG. 2, the projections 18t are illustrated in a state in which the tips of the projections are deformed after being thermally caulked. The same applies to other figures illustrating the projections 18t. The projections 18t may be cold caulked and fixed to the outer joints 26d.

The left lower plate spring 26L is connected to the optical element holder 2 via one inner joint 26c and to the base member 18 via two outer joints 26d. The same applies to the right lower plate spring 26R. With this configuration, the left lower plate spring 26L and the right lower plate spring 26R can support the optical element holder 2 in a well-balanced manner in a state movable in the optical-axis direction.

Next, an example of a connection structure of the coil 3, the first terminal member 7A, the second terminal member 7B, the left metal member 8L, the right metal member 8R, the left lower plate spring 26L, and the right lower plate spring 26R will be described with reference to FIG. 10.

The right connecting plate 26hR of the right lower plate spring 26R is configured to face the right exposed portion 8PR of the right metal member 8R embedded in the optical element holder 2. Specifically, the right lower plate spring 26R is configured such that a surface of the right connecting plate 26hR on the subject side (Z1 side) contacts a surface of the right exposed portion 8PR on the image sensor side (Z2 side). The same applies to the left lower plate spring 26L.

One of the two outer joints 26d of the right lower plate spring 26R is configured to face an exposed portion 7AP of the first terminal member 7A embedded in the base member 18. Specifically, the first terminal member 7A is embedded in the base member 18 such that an upper surface of the exposed portion 7AP is exposed at a recess 18r (see FIG. 2) on the upper surface of the base member 18. The right lower plate spring 26R is configured such that the surface of the corresponding outer joint 26d on the image sensor side (Z2 side) contacts a surface of the exposed portion 7AP of the first terminal member 7A on the subject side (Z1 side). The same applies to the left lower plate spring 26L.

The right extended-wire portion 33R of the coil 3 is wound around the right extension 8CR of the right metal member 8R, as illustrated in the upper figure of FIG. 10. The right extended-wire portion 33R and the right extension 8CR are joined by laser welding. The right extended-wire portion 33R and the right extension 8CR may be joined by solder, conductive adhesive, or the like. The same applies to the left extended-wire portion 33L of the coil 3.

Next, the fixed-side member FB will be described. The fixed-side member FB includes the spacer 1, the cover 4, and the magnets 5, for fixing the upper plate spring 16, and the base member 18 for fixing the lower plate springs 26.

The base member 18 is manufactured by injection molding by using a synthetic resin such as a liquid crystal polymer. In the present embodiment, as illustrated in FIG. 2, the base member 18 is a member having a substantially rectangular outer shape, and a substantially circular opening portion 18k is formed in the center thereof. On the surface (upper surface) of the base member 18 on the subject side (Z1 side), the six projections 18t each having a round shape projecting upward from the base member 18 are provided.

Furthermore, as illustrated in FIG. 2, the terminal members 7 formed of a metal plate containing a material such as copper, iron, or an alloy mainly composed of them are inserted and embedded in the base member 18. The terminal members 7 include the first terminal member 7A to the third terminal member 7C. The first terminal member 7A and the second terminal member 7B are configured such that the exposed portion 7AP of the first terminal member 7A and an exposed portion 7BP of the second terminal member 7B are exposed to the upper surface (Z1-side surface) of the base member 18. The first terminal member 7A and the second terminal member 7B are electrically and mechanically connected to a substrate (not illustrated) on which an image sensor is mounted via terminal portions 7AT and 7BT respectively extending downward (Z2 direction) from front side (X1 side) ends of the base member 18. As illustrated in the lower figure of FIG. 10, the first terminal member 7A is electrically and mechanically connected to the right lower plate spring 26R by laser welding at a through hole 26t in the exposed portion 7AP formed in the outer joint 26d of the right lower plate spring 26R. Similarly, the second terminal member 7B is electrically and mechanically connected to the left lower plate spring 26L by laser welding at the through hole 26t in the exposed portion 7BP formed in the outer joint 26d of the left lower plate spring 26L. Furthermore, as illustrated in the lower figure of FIG. 10, the right lower plate spring 26R is electrically and mechanically connected to the right exposed portion 8PR of the right metal member 8R by laser welding at a through hole 26u (see the upper figure of FIG. 9) formed in the right connecting plate 26hR of the right lower plate spring 26R. Similarly, the left lower plate spring 26L is electrically and mechanically connected to the left exposed portion 8PL of the left metal member 8L by laser welding at the through hole 26u (see the upper figure of FIG. 9) formed in the left connecting plate 26hL of the left lower plate spring 26L. In the upper figure of FIG. 9, welding marks WD1 indicate the welding marks between the terminal members 7 and the lower plate springs 26, and welding marks WD2 indicate the welding marks between the metal members 8 and the lower plate springs 26. The connections between each of the terminal members 7 and the metal members 8 with the corresponding lower plate springs 26 may be achieved by solder or a bonding material such as a conductive adhesive.

With this configuration, the right extended-wire portion 33R of the coil 3 is connected to an external first potential through the right metal member 8R, the right lower plate spring 26R, and the first terminal member 7A, and the left extended-wire portion 33L of the coil 3 is connected to an external second potential (different from the first potential) through the left metal member 8L, the left lower plate spring 26L, and the second terminal member 7B. Therefore, the coil 3 can receive the current supply through the terminal members 7, the metal members 8, and the lower plate springs 26.

As illustrated in FIG. 2, the third terminal member 7C includes four connecting portions 7CP. Specifically, as illustrated in FIG. 1, the third terminal member 7C includes four connecting portions 7CP exposed on the upper surface of the base member 18 so as to correspond to lower-end portions of the four corners of the cover 4. The base member 18 is fixed to the cover 4 by welding the connecting portions 7CP and the lower-end portions of the four corners of the cover 4 as illustrated in FIG. 1 after an inner surface of the lower-end portion of the outer peripheral wall 4A of the cover 4 and an outer peripheral surface of the base member 18 are combined and positioned. The cover 4 and the base member 18 may be fixed at least partially by an adhesive. As a result, the third terminal member 7C and the cover 4 are electrically combined and grounded via a terminal portion 4T of the cover 4.

Next, vibration dampers DM for suppressing vibration of the optical element holder 2 will be described. As illustrated in FIG. 3, each of the vibration dampers DM is accommodated in a corresponding housing portion SP formed on the lower surface of the spacer 1. In FIG. 3, a cross pattern is applied to a first vibration damper DM1 to a fourth vibration damper DM4 for clarity, and a dot pattern is applied to the optical element holder 2.

Specifically, as illustrated in the upper figure of FIG. 7, the spacer 1 includes four fixed-side corners 1C corresponding to four corners of the housing HS (see FIG. 1). Each of the four fixed-side corners 1C includes a projecting portion 1P projecting downward thereof. Specifically, the fixed-side corners 1C include a first fixed-side corner 1C1 to a fourth fixed-side corner 1C4, and the projecting portions 1P include a first projecting portion 1P1 to a fourth projecting portion 1P4.

The housing portions SP are formed on lower surfaces (Z2-side surfaces) of the four projecting portions 1P, respectively, so as to recess upward (in the Z1 direction) toward the subject. Specifically, the housing portions SP include a first housing portion SP1 to a fourth housing portion SP4. The first housing portion SP1 is formed on the lower surface of the first projecting portion 1P1, the second housing portion SP2 is formed on the lower surface of the second projecting portion 1P2, the third housing portion SP3 is formed on the lower surface of the third projecting portion 1P3, and the fourth housing portion SP4 is formed on the lower surface of the fourth projecting portion 1P4.

The vibration dampers DM are members for suppressing vibration of the optical element holder 2. The vibration dampers DM are arranged so as to connect the optical element holder 2 and the fixed-side member FB, and are configured so as to be elastically stretchable according to the relative movement of the optical element holder 2 with respect to the fixed-side member FB. In the illustrated example, the vibration dampers DM are configured so as to suppress vibration of the optical element holder 2 without affecting the original movement of the optical element holder 2 achieved by the driver MP, that is, to have a stiffness and a shape capable of exhibiting a sufficient vibration damping performance.

Specifically, the vibration dampers DM are gel-like vibration damper members formed by curing a flowable adhesive with ultraviolet rays or heat, and include the first vibration damper DM1 to the fourth vibration damper DM4 as illustrated in FIG. 3. In the illustrated example, the vibration dampers DM are ultraviolet-curing gel-like vibration damper members. The housing portion SP is also called a gel pocket. More specifically, the first vibration damper DM1 is accommodated in the first housing portion SP1, the second vibration damper DM2 is accommodated in the second housing portion SP2, the third vibration damper DM3 is accommodated in the third housing portion SP3, and the fourth vibration damper DM4 is accommodated in the fourth housing portion SP4. The vibration dampers DM may be made of a thermosetting resin, an ultraviolet-curing resin, a thermosetting silicone rubber, an ultraviolet-curing silicone rubber, or the like.

As illustrated in the center figure of FIG. 5, the metal members 8 include upwardly-extended portions 8T as projections PT extending upward (in the Z1 direction) from the bases 8M. The projections PT are also called damping pins. Specifically, as illustrated in FIG. 3, the projections PT include a first projection PT1 (a front-right upwardly-extended portion 8TFR) corresponding to the first vibration damper DM1 accommodated in the first housing portion SP1, a second projection PT2 (a front-left upwardly-extended portion 8TFL) corresponding to the second vibration damper DM2 accommodated in the second housing portion SP2, a third projection PT3 (a rear-left upwardly-extended portion 8TBL) corresponding to the third vibration damper DM3 accommodated in the third housing portion SP3, and a fourth projection PT4 (a rear-right upwardly-extended portion 8TBR) corresponding to the fourth vibration damper DM4 accommodated in the fourth housing portion SP4.

Specifically, as illustrated in the upper figure of FIG. 6, the four projections PT are arranged at positions separated by the same distance from the optical axis OA. The upper figure of FIG. 6 illustrates that the four projections PT are located on the circumference of a circle RG1 parallel to the XY plane centered on the optical axis OA. The upper figure of FIG. 6 illustrates that the first projection PT1 (the front-right upwardly-extended portion 8TFR) is positioned on the front side (X1 side) of a first diagonal line DL1, the second projection PT2 (the front-left upwardly-extended portion 8TFL) is positioned on the front side (X1 side) of a second diagonal line DL2, the third projection PT3 (the left-rear upwardly-extended portion 8TBL) is positioned on the rear side (X2 side) of the first diagonal line DL1, and the fourth projection PT4 (the rear-right upwardly-extended portion 8TBR) is positioned on the rear side (X2 side) of the second diagonal line DL2. Each of the first diagonal line DL1 and the second diagonal line DL2 is a diagonal line about a square surrounding the optical element holder 2 in the XY plane and passes through the optical axis OA.

As illustrated in FIG. 8, the second projection PT2 includes a tip ED inserted into the second housing portion SP2. The tip ED is in contact with the second vibration damper DM2 accommodated in the second housing portion SP2 in an initial state of the optical element drive device 101. The initial state of the optical element drive device 101 is, for example, a state of the optical element drive device 101 when the Z1 direction is a vertically upward direction and no current is supplied to the coil 3. The same applies to the first projection PT1, the third projection PT3, and the fourth projection PT4.

As illustrated in FIG. 7, optical element holder 2 includes four movable-side corners 2C corresponding to the four corners of the housing HS (see FIG. 1). Each of the four movable-side corners 2C is formed with a through-hole portion 2h for receiving a part of the projecting portion 1P so as not to contact the projecting portion 1P of the spacer 1. Specifically, a first movable-side corner 2C1 includes a first through-hole portion 2h1 for receiving a part of the first projecting portion 1P1 so as not to contact the first projecting portion 1P1, a second movable-side corner 2C2 includes a second through-hole portion 2h2 for receiving a part of the second projecting portion 1P2 so as not to contact the second projecting portion 1P2, a third movable-side corner 2C3 includes a third through-hole portion 2h3 for receiving a part of the third projecting portion 1P3 so as not to contact the third projecting portion 1P3, and a fourth movable-side corner 2C4 includes a fourth through-hole portion 2h4 for receiving a part of the fourth projecting portion 1P4 so as not to contact the fourth projecting portion 1P4.

As illustrated in FIG. 2, the base member 18 includes four base-side corners 18C corresponding to the four corners of the housing HS (see FIG. 1). Each of the four base-side corners 18C is provided with an opening portion 18h configured to expose the housing portion SP therefrom. Specifically, as illustrated in FIG. 3, a first opening portion 18h1 for exposing the first housing portion SP1 therefrom is formed in a first base-side corner 18C1, a second opening portion 18h2 for exposing the second housing portion SP2 therefrom is formed in a second base-side corner 18C2, a third opening portion 18h3 for exposing the third housing portion SP3 therefrom is formed in a third base-side corner 18C3, and a fourth opening portion 18h4 for exposing the fourth housing portion SP4 therefrom is formed in a fourth base-side corner 18C4. The first opening portion 18h1 to the fourth opening portion 18h4 are formed of cutouts cut outward from the substantially circular opening portion 18k formed in the base member 18.

With this configuration, a fluid adhesive (liquid adhesive), which is a material of the vibration dampers DM, can be readily accommodated (injected) into the housing portions SP by using, for example, a slender nozzle, even after the optical element drive device 101 is assembled, and an amount of the adhesive injection can be readily controlled. After the optical element drive device 101 is assembled, that is, in a state where the liquid adhesive is in contact with the tips ED of the projections PT that are correspondingly inserted into the housing portions SP, the liquid adhesive is cured by, for example, irradiation with ultraviolet rays to become the vibration dampers DM. Typically, the nozzle for injecting the liquid adhesive is inserted so as to penetrate through the opening portion 18h of the base member 18 and the through-hole portion 2h of the optical element holder 2 of the optical element drive device 101 that is assembled and disposed upside down. The liquid adhesive injected into the housing portion SP through the nozzle is visible from below (Z2 side) as illustrated in FIG. 3, and is cured by irradiation with ultraviolet rays from below. In other words, when the ultraviolet curable vibration dampers DM are employed, the opening portions 18h of the base member 18 and the through-hole portions 2h of the optical element holder 2 are configured such that their respective opening areas are larger than an opening area of the housing portions SP.

With this configuration, the optical element drive device 101 suppresses undesired vibration of the optical element holder 2 by using the vibration dampers DM, and since the openings for injecting and curing the fluid adhesive (liquid adhesive), that is the material of the vibration dampers DM, are not formed on upper and outer surfaces of the housing HS, entry of foreign substances through such openings can be suppressed.

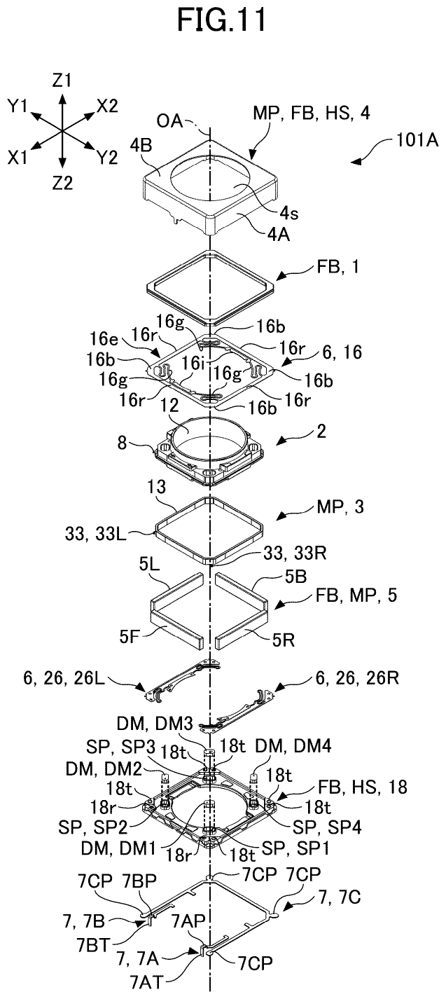

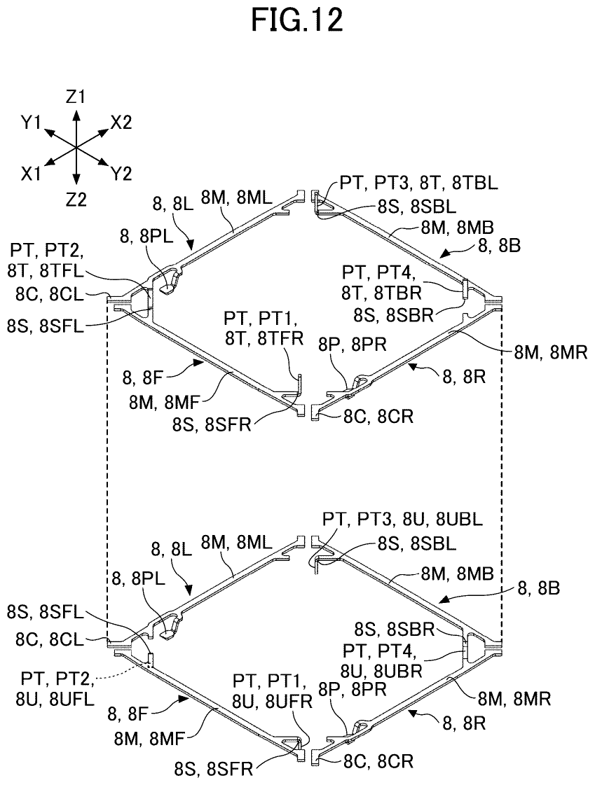

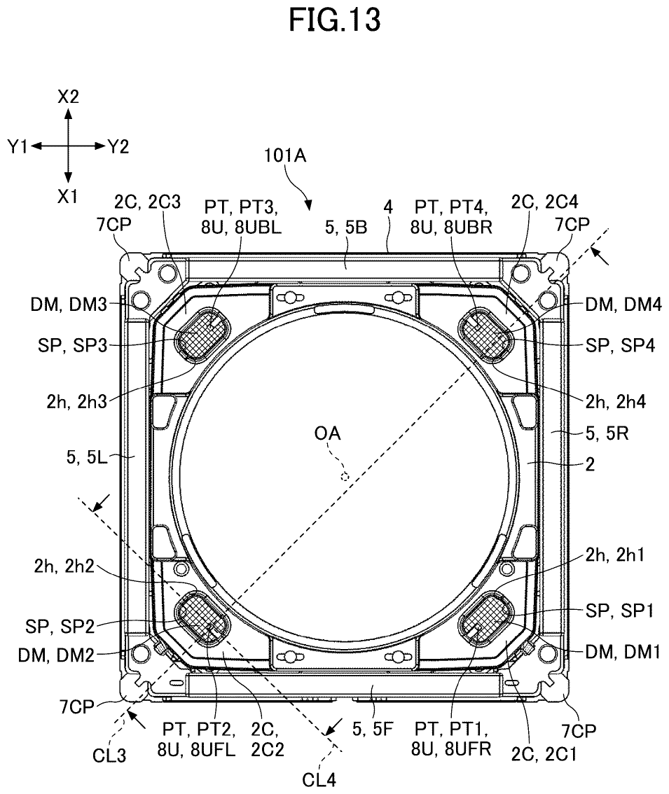

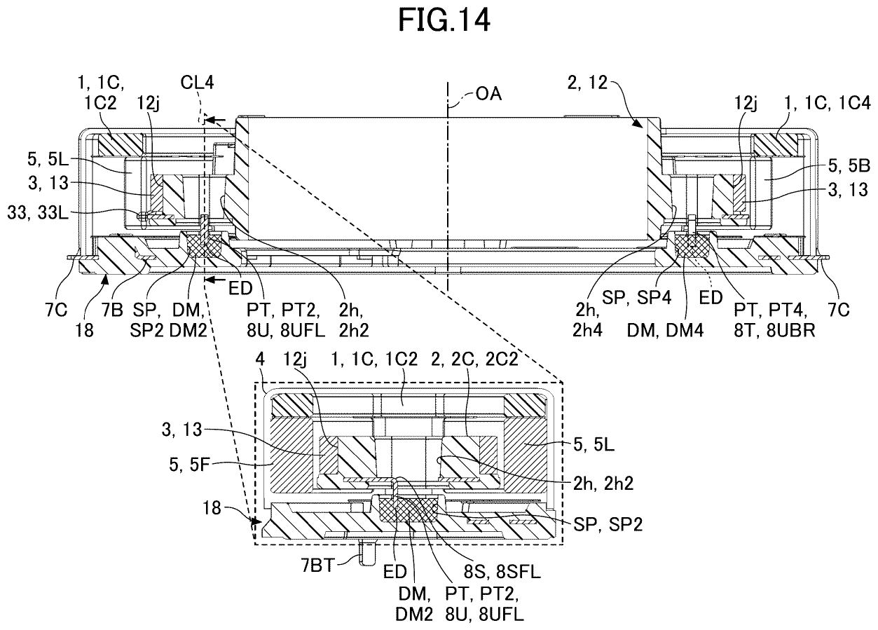

Next, with reference to FIGS. 11 to 14, an optical element drive device 101A, which is another configuration example of the optical element drive device 101 according to the embodiment of the present disclosure, will be described. FIG. 11 is an exploded perspective view of the optical element drive device 101A, which corresponds to FIG. 2. FIG. 12 is upper perspective views of the metal members 8 embedded in the optical element holder 2. Specifically, the upper figure of FIG. 12 is a perspective view of the metal members 8 included in the optical element drive device 101, and the lower figure of FIG. 12 is a perspective view of the metal members 8 included in the optical element drive device 101A. FIG. 13 is a top view of the optical element drive device 101A with the spacer 1, the cover 4, and the upper plate spring 16 removed. FIG. 14 is a cross-sectional view of the optical element drive device 101A, and corresponds to FIG. 8. Specifically, the upper figure of FIG. 14 illustrates a cross-sectional view of the optical element drive device 101A in an imaginary plane parallel to the optical axis OA, including a cutting line CL3 in FIG. 13. The lower figure of FIG. 14 illustrates a cross-sectional view of the optical element drive device 101A in an imaginary plane parallel to the optical axis OA, including a cutting line CL4 (perpendicular to the cutting line CL3) in FIG. 13 and the upper figure of FIG. 14.

The optical element drive device 101A differs from the optical element drive device 101 in that the housing portion SP is formed in the base member 18, as illustrated in FIG. 11. In the optical element drive device 101, the housing portion SP is formed in the spacer 1.

The optical element drive device 101A differs from the optical element drive device 101 in that the projections PT extend downward from the bases 8M of the metal members 8, as illustrated in the lower figure of FIG. 12. In the optical element drive device 101, as illustrated in the upper figure of FIG. 12, the projections PT extend upward from the bases 8M of the metal members 8.

Specifically, as illustrated in the lower figure of FIG. 12, the metal members 8 constituting the optical element drive device 101A include downwardly-extended portions 8U as the projections PT extending downward (in the Z2 direction) from the bases 8M. Specifically, as illustrated in FIG. 13, the projections PT include a first projection PT1 (front-right downwardly-extended portion 8UFR) corresponding to the first vibration damper DM1 accommodated in the first housing portion SP1, a second projection PT2 (front-left downwardly-extended portion 8UFL) corresponding to the second vibration damper DM2 accommodated in the second housing portion SP2, a third projection PT3 (rear-left downwardly-extended portion 8UBL) corresponding to the third vibration damper DM3 accommodated in the third housing portion SP3, and a fourth projection PT4 (rear-right downwardly-extended portion 8UBR) corresponding to the fourth vibration damper DM4 accommodated in the fourth housing portion SP4.

With this configuration, the optical element drive device 101A brings about the same effect as the optical element drive device 101. More specifically, the vibration dampers DM suppress undesired vibration of the optical element holder 2, while suppressing entry of foreign substances into the optical element drive device 101A. In the optical element drive device 101A, the injection and curing of the fluid adhesive (liquid adhesive) which is the material of the vibration damper DM are typically performed after the upper plate spring 16 is assembled to the optical element holder 2, but may be performed before the upper plate spring 16 is assembled to the optical element holder 2.

As described above, the optical element drive device 101 according to the embodiment of the present disclosure includes, as illustrated in FIG. 2, the fixed-side member FB, the optical element holder 2 including the through-hole portion (cylindrical portion 12) penetrating in the vertical direction and capable of holding the optical element, support members (the plate springs 6) supporting the optical element holder 2 so as to be movable in the vertical direction, and the driver MP for moving the optical element holder 2 at least in the vertical direction with respect to the fixed-side member FB. The fixed-side member FB includes the housing portions SP that are open at least on one of the upper or lower side. In the example as illustrated in FIGS. 1 to 10, the spacer 1 as the fixed-side member FB includes the housing portions SP that are open on the lower side as illustrated in FIG. 7. In the example as illustrated in FIGS. 11 to 14, the base member 18 as the fixed-side member FB includes the housing portions SP that are open on the upper side as illustrated in FIG. 11. The optical element holder 2 includes the projections PT whose tips are inserted into the housing portions SP. The housing portion SP contains the vibration damper DM. Each of the tips of the projections PT contacts the vibration damper DM provided in the housing portion SP. The projections PT may be a part of another member held by the optical element holder 2 or a part of the optical element holder 2. That is, the projections PT may be formed of a synthetic resin.

In this configuration, since the projections PT are provided in the optical element holder 2, it is not necessary to increase the size of the opening in the ceiling (e.g., the opening in the ceiling 4B of the cover 4) of the housing HS or the like as an external component which constitutes the fixed-side member FB, in order to provide the projections PT in a part of the ceiling, and thus entry of foreign substances can be suppressed. In addition, the area of the ceiling (e.g., the ceiling 4B of the cover 4) does not increase.

Desirably, the projections PT are formed of a metal. This configuration has the effect that the projections PT can be formed thinner than when the projections PT are formed of a synthetic resin. Therefore, this configuration has the effect of suppressing the vibration suppressing effect (vibration damping effect) from being excessively effective and hindering the drive by the driver MP. This configuration has the effect that the strength of the projections PT can be increased compared with when the projections PT are formed of a synthetic resin. This configuration has the effect that the deterioration of the projections PT can be suppressed when the fluid adhesive (liquid adhesive), which is the material of the vibration dampers DM, is cured by ultraviolet irradiation.

In addition, desirably, the metal members 8 are embedded in the optical element holder 2. The projections PT are formed as a part of the metal members 8 and are exposed from the optical element holder 2. In the illustrated example, as illustrated in FIG. 5, the projections PT include the front-right upwardly-extended portion 8TFR and a front-left upwardly-extended portion 8TFL that are formed in the front metal member 8F embedded in the optical element holder 2, and the left-rear upwardly-extended portion 8TBL and the rear-right upwardly-extended portion 8TBR that are formed in the rear metal member 8B embedded in the optical element holder 2.

This configuration has the effect that the productivity of the optical element drive device 101 is enhanced compared with the configuration in which the projections PT are fixed to the optical element holder 2 with an adhesive.

Desirably, each of the metal members 8 is formed of a metal plate and includes the base 8M embedded in the optical element holder 2. The base 8M has a portion wider than a width of the tip ED of the projection PT. In the example as illustrated in the center figure of FIG. 5, a width DS1 of the rear base 8MB of the rear metal member 8B is larger than a width DS2 of the tip ED of the rear-right upwardly-extended portion 8TBR as the projection PT.

This configuration has the effect that the projections PT can be reliably supported by the optical element holder 2.

Preferably, the metal member 8 includes a bent portion 8S between the base 8M and each of the projections PT (the upwardly-extended portions 8T). In the example as illustrated in the center figure of FIG. 5, the front metal member 8F includes a front-right bent portion 8SFR between the front base 8MF and the front-right upwardly-extended portion 8TFR which is the projection PT, and a front-left bent portion 8SFL between the front base 8MF and the front-left upwardly-extended portion 8TFL which is another projection PT. The rear metal member 8B includes a rear-right bent portion 8SBR between the rear base 8MB and the rear-right upwardly-extended portion 8TBR which is another projection PT, and a rear-left bent portion 8SBL between the rear base 8MB and the left-rear upwardly-extended portion 8TBL which is another projection PT.

This configuration has the effect that the projections PT can be readily formed by bending the metal members 8.

Preferably, the optical element holder 2 includes the through-hole portions 2h from which the housing portion SP are exposed, as illustrated in FIG. 3. In this case, the spacer 1 may include projecting portions 1P which protrude downward from the spacer 1, as illustrated in FIG. 7. The housing portions SP may be provided on a lower-surface side of the projecting portions 1P. In the illustrated example, the projecting portions 1P are inserted into the through-hole portions 2h, respectively, formed in the movable-side corners 2C of the optical element holder 2, as illustrated in FIG. 8, and respectively enter the corresponding through-hole portion 2h by a distance DS3 in the optical-axis direction. That is, at least a part of each housing portion SP is disposed inside the optical element holder 2. Furthermore, each projection PT is configured so as to be embedded in the vibration damper DM by a distance DS4 (smaller than the distance DS3) in the optical-axis direction.

This configuration has the effect of facilitating the installation of the vibration dampers DM. Specifically, this configuration has the effect of facilitating the injection of a fluid adhesive (liquid adhesive) which is the material of the vibration dampers DM and curing of the liquid adhesive injected into the housing portions SP by ultraviolet irradiation. This is because a distance from the lower surface of the base member 18 to each housing portion SP is shorter than in a case where the housing portions SP are disposed outside the optical element holder 2. In addition, this configuration has the effect of shortening the length of the upwardly-extended portions 8T as the projections PT compared to the case where the housing portions SP are disposed outside the optical element holder 2. Therefore, this configuration has the effect of suppressing undesired vibration of the optical element holder 2 at an earlier timing. This is because the upwardly-extended portions 8T can be suppressed from being undesirably long.

Preferably, the support members (plate springs 6) include the upper plate spring 16 fixed to the upper part of the optical element holder 2 and the lower plate springs 26 fixed to the lower part of the optical element holder 2, as illustrated in FIG. 2. The fixed-side member FB includes the base member 18, the cover 4 integrated with the base member 18, and the spacer 1 disposed between the ceiling 4B of the cover 4 and the upper plate spring 16, as illustrated in FIG. 2. The housing portions SP are provided on a lower-surface side of the spacer 1, as illustrated in FIG. 7.

As compared with the case where the housing portions SP are formed on a member other than the spacer 1, this configuration has the effect that foreign substances are less likely to enter the vibration damper DM. This is because it is not necessary to form openings or the like for injection and curing of a fluid adhesive (liquid adhesive), which is the material of the vibration dampers DM, on the upper and outer circumferential surfaces of the housing HS, that is, the entry of foreign substances through such openings can be suppressed.

Preferably, the base member 18 includes the opening portions 18h configured to expose the housing portions SP therefrom, as illustrated in FIG. 3.

This configuration has the effect that the vibration dampers DM can be readily arranged. Specifically, this configuration has the effect of facilitating injection of a fluid adhesive (liquid adhesive) which is the material of the vibration damper DM and curing of the liquid adhesive injected into the housing portions SP by ultraviolet irradiation.

The housing portions SP may be provided on the upper-surface side of the base member 18 as illustrated in FIG. 11.

As in the case where the housing portions SP are provided on the spacer 1, this configuration has the effect that it is not necessary to increase the size of the opening in the ceiling (e.g., the opening in the ceiling 4B of the cover 4) of the housing HS or the like as an external component of the fixed-side member FB, and thus entry of foreign substances can be suppressed.

The optical element drive device described above can suppress entry of the foreign substances into the optical element drive device while suppressing undesired vibration of the optical element holder.

The above-described preferred embodiments have been described in detail. However, the present invention is not limited to the above-described embodiments. The above-described embodiments can be modified or replaced without departing from the scope of the present invention. Each of the features described with reference to the above-described embodiments may be appropriately combined as long as there is no technical contradiction.

For example, in the above-described embodiment, the driver MP is configured to move the optical element holder 2 in the vertical direction, but it may be configured to move the optical element holder 2 in a longitudinal direction or a lateral direction. The driver MP may be configured to rotate about at least one of the X-axis, Y-axis, or Z-axis.

What is claimed is:

1. An optical element drive device, comprising:
a fixed-side member;
an optical element holder that includes a through-hole portion penetrating therethrough in a vertical direction and capable of holding an optical element;
a support member configured to support the optical element holder so as to be movable in the vertical direction; and
a driver configured to move the optical element holder at least in the vertical direction with respect to the fixed-side member, wherein
the fixed-side member includes a housing portion open at least on one of an upper side or a lower side,
the optical element holder includes a projection a tip thereof being inserted into the housing portion,
a vibration damper is accommodated in the housing portion, and
the tip of the projection contacts the vibration damper provided in the housing portion.

2. The optical element drive device according to claim 1, wherein
the projection is formed of a metal.

3. The optical element drive device according to claim 2, wherein
a metal member is embedded in the optical element holder, and
the projection is formed as a part of the metal member and is exposed from the optical element holder.

4. The optical element drive device according to claim 3, wherein
the metal member is formed of a metal plate and includes a base embedded in the optical element holder, and
the base includes a portion wider than a width of the tip of the projection.

5. The optical element drive device according to claim 4, wherein
the metal member includes a bent portion between the base and the projection.

6. The optical element drive device according to claim 1, wherein
the optical element holder includes a through-hole portion the housing portion is exposed therefrom.

7. The optical element drive device according to claim 1, wherein
the support member includes an upper plate spring fixed to an upper part of the optical element holder, and lower plate springs fixed to a lower part of the optical element holder,
the fixed-side member includes a base member, a cover integrated with the base member, and a spacer disposed between a ceiling of the cover and the upper plate spring, and
the housing portion is provided on a lower-surface side of the spacer.

8. The optical element drive device according to claim 7, wherein
the base member includes an opening portion configured to expose the housing portion therefrom.

9. The optical element drive device according to claim 1, wherein
the support member includes an upper plate spring fixed to an upper part of the optical element holder, and lower plate springs fixed to a lower part of the optical element holder,
the fixed-side member includes a base member, and a cover integrated with the base member, and
the housing portion is provided on an upper-surface side of the base member.
